(19) United States
(12) Patent Application Publication
(10) Pub. No.: US 2022/0322691 A1
(43) Pub. Date: Oct. 13, 2022

(54) Method of Making Discrete Frozen Particles of Coconut Fat and a Meat Analogue with the Same

(71) Applicants: Thomas R. Mosey, Boca Raton, FL (US); Tonghark Food Co., Ltd., Seoul (KR)

(72) Inventors: Sangsuk Lee, Seoul (KR); Nankyung Kye, Seoul (KR)

(21) Appl. No.: 17/226,634

(22) Filed: Apr. 9, 2021

(51) Int. Cl. A23D 9/04

(52) U.S. Cl. CPC A23D 9/04

(57) ABSTRACT

A method of making discrete frozen particles of coconut fat from coconut fat includes freezing coconut fat until the temperature of the coconut fat is reduced to a temperature in the range of −5 to −30 degrees Fahrenheit to form a first frozen block of coconut fat, flash freezing the first frozen block of coconut fat until the temperature of the first frozen block of coconut fat is reduced to a temperature in the range of −130 to −175 degrees Fahrenheit to form a second frozen block of coconut fat, and breaking the frozen coconut fat into discrete frozen particles. A method of making a meat analogue with coconut fat includes the foregoing steps and adding the discrete frozen particles to a meat analogue while cooking or after cooking and mixing the discrete frozen particles into the meat analogue to form an unhomogenized mixture of melted coconut fat and meat analogue.

### FIELD OF THE DISCLOSED TECHNOLOGY

The disclosed technology relates generally to a method of making meat analogues. More specifically, the present disclosed technology relates to a method of making discrete frozen particles of coconut fat and then making a meat analogue with the same.

### BACKGROUND

Coconut fat is typically used in conventional methods of making and/or cooking meat analogues. These methods typically involve an underutilization or inefficient methods of keeping and/or getting the coconut fat into the meat analogue. Indeed, these methods typically involve mixing room temperature coconut fat with the meat analogue while the meat analogue is cooking. At ˜75 degrees Fahrenheit, the coconut fat becomes a liquid and then sublimates while cooking the meat analogue, causing the coconut fat to melt out of the meat analogue, leaving it dry. Once the meat analogue cools down, the coconut fat converts back into solid deposits having a bigger and inconsistent shape that are not absorbed by the meat analogue. The foregoing is not ideal because the meat analogue is left dry with larger deposits of coconut fat present in the meat analogue.

Accordingly, there is a need for a method of generating smaller discrete frozen particles of coconut fat that aid in the meat analogue making process and prevent the drying out of meat analogues while cooking.

### SUMMARY OF THE DISCLOSED TECHNOLOGY

Disclosed herein is a method of making discrete frozen particles of coconut fat from coconut fat. The method includes the steps of freezing a predetermined quantity of coconut fat until the temperature of the coconut fat is reduced to a temperature in the range of 50 to −30 degrees Fahrenheit to form a first frozen block of coconut fat. Next, the method includes flash freezing the first frozen block of coconut fat until the temperature of the first frozen block of coconut fat is reduced to a temperature in the range of −130 to −175 degrees Fahrenheit to form a second frozen block of coconut fat. Lastly, the method includes breaking the second frozen block of coconut fat into discrete frozen particles.

Also disclosed herein is a method of making a meat analogue with coconut fat. The method includes freezing coconut fat until the temperature of the coconut fat is reduced to a temperature in the range of −5 to −30 degrees Fahrenheit to form a first frozen block of coconut fat. Next, the method includes flash freezing the first frozen block of coconut fat until the temperature of the first frozen block of coconut fat is reduced to a temperature in the range of −130 to −175 degrees Fahrenheit to form a second frozen block of coconut fat. Next, the method includes breaking the second frozen block of coconut fat into discrete frozen particles. Next, the method includes adding the discrete frozen particles while still frozen to a meat analogue while the meat analogue is being cooked. Lastly, the method includes mixing the discrete frozen particles into the meat analogue in an unhomogenized way while the meat analogue is being cooked to melt the discrete frozen particles and form an unhomogenized mixture of melted coconut fat and meat analogue.

In embodiments, the steps of flash freezing the first frozen block of coconut fat include applying liquid nitrogen directly onto the first frozen block of coconut fat.

In some embodiments, the steps of breaking the second frozen block of coconut fat into discrete frozen particles include applying a blunt force directly to the second frozen block of coconut fat.

In other embodiments, the steps of breaking the second frozen block of coconut fat into discrete frozen particles include breaking the second frozen block of coconut into discrete frozen particles that include a diameter in the range of 1.5 mm to 2.5 mm in diameter.

In certain embodiments, the blunt force is applied with a hammer, pulverizer, or a roller.

In embodiments, the steps of freezing the coconut fat until the temperature of the coconut fat is reduced to a temperature in the range of 50 to −30 degrees Fahrenheit to form a first frozen block of coconut fat include freezing the coconut fat until the temperature of the coconut fat is reduced to a temperature in the range of −15 to −20 degrees Fahrenheit.

In some embodiments, the steps of flash freezing the first frozen block of coconut fat until the temperature of the first frozen block of coconut fat is reduced to a temperature in the range of −130 to −175 degrees Fahrenheit to form a second frozen block of coconut fat includes flash freezing the first frozen block of coconut fat until the temperature of the first frozen block of coconut fat is reduced to substantially −150 degrees Fahrenheit.

In certain embodiments, the coconut fat includes a weight in the range of 50-150 grams.

In other embodiments, the methods further include a step of depositing the coconut fat into an insulated container prior to freezing the coconut fat. The insulated container includes four insulated walls, an insulated base, an interior volume, and a top including an opening providing access to the interior volume, wherein the coconut fat is deposited into interior volume of the container.

In some embodiments, the steps of freezing the coconut fat until the temperature of the coconut fat is reduced to a temperature in the range of 50 to −30 degrees Fahrenheit to form the first frozen block of coconut fat include directionally freezing the coconut fat by freezing the container with the top left open and exposed to the freezing cold environment.

“Coconut fat” as referenced herein also includes and/or refers to “coconut oil” and can also refer to “coconut butter or a coconut fat/coconut butter mix, which may contain other stabilizers and emulsifiers.” “Meat analogue” also known as “plant-based meat,” “vegan meat,” “meat substitute,” “mock meat,” “meat alternative,” “imitation meat,” “vegetarian meat,” is defined as “a meat-like substance made from plants.” “Flash freezing” is defined as “the process whereby objects are frozen by subjecting them to cryogenic temperatures, or through direct contact with liquid nitrogen.” “Cryogenic temperature” is defined as “temperature that is in the range of −150° C. (−238° F.) to absolute zero, i.e, −273° C. (−460° F.).” “Block” is defined as “a condensed quantity of an item, good, such as food.” “Condensed” is defined as “made denser, compressed, or concentrated.” “Discrete” is defined as “individually separate and distinct.” “Particle” is defined as “a minute portion of matter, including a diameter less than 15 millimeters (mm).” “Emulsion” is defined as “a fine dispersion of minute droplets of one liquid in another in which it is not soluble or miscible.” “Homogenous” is defined as “uniform throughout or being all the same or all of the same kind.” “Sublimate” is defined as “change directly into vapor when heated, and forming a solid deposit again on cooling.” “Blunt force” is defined as “impact with a blunt object or one that does not possess any sharp edges.” “Pea-sized” is defined as “having a diameter ranging between 7 mm to 9 mm.” “Directionally freezing” is defined as “Directional freezing” is defined as “the process of controlling the direction that a substance is frozen to in order to freeze out impurities, such as air bubbles, from the substance.”

Any device or step to a method described in this disclosure can comprise or consist of that which it is a part of, or the parts which make up the device or step. The term “and/or” is inclusive of the items which it joins linguistically and each item by itself. “Substantially” is defined as “at least 95% of the term being described” and any device or aspect of a device or method described herein can be read as “comprising” or “consisting” thereof.

### BRIEF DESCRIPTION OF THE DRAWINGS

FIG. 1 shows a high-level flow chart of a method of making discrete frozen particles of coconut fat according to one embodiment of present disclosed technology.

FIG. 2 shows a high-level flow chart of a method of making a meat analogue with coconut fat according to one embodiment of present disclosed technology.

### DETAILED DESCRIPTION OF EMBODIMENTS OF THE DISCLOSED TECHNOLOGY

The disclosed technology provides a method of making discrete frozen particles of coconut fat from a larger quantity of condensed coconut fat including the steps of freezing coconut fat to a temperature in the range of 50 to −30 degrees Fahrenheit, flash freezing the frozen coconut fat to a temperature in the range of −130 to −175 degrees Fahrenheit, and breaking the frozen coconut fat into discrete frozen particles. The disclosed technology also provides a method of making a meat analogue with coconut fat including the foregoing steps as well as the steps of adding the discrete frozen particles to a meat analogue while being cooked and mixing the discrete frozen particles into the meat analogue to melt the discrete frozen particles and form an unhomogenized mixture of melted coconut fat and meat analogue.

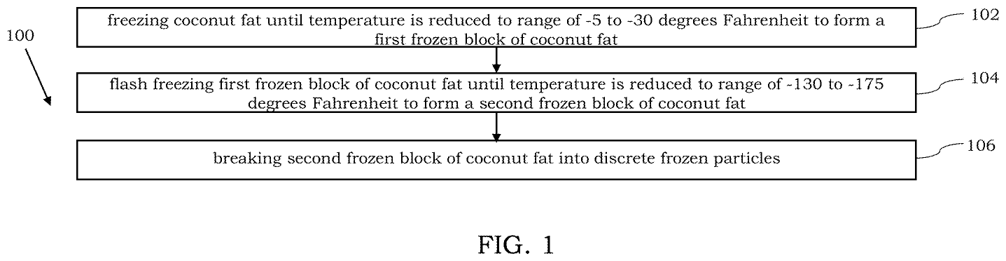

Referring now to FIG. 1, there is shown a high-level flow chart of a method of making discrete frozen particles of coconut fat according to one embodiment of present disclosed technology. The method 100 of making discrete frozen particulates of coconut fat from a larger quantity of condensed coconut fat is for the purpose of placing coconut fat into a condition best suitable for cooking with a meat analogue such that the coconut fat mixes best with and does not come out of the meat analogue while cooking. The method 100 comprises first freezing a predetermined amount or quantity of coconut fat until the temperature of the coconut fat is reduced to a temperature in the range of 50 to −30 degrees Fahrenheit to form a first frozen block of coconut fat 102?. In embodiments, the coconut fat is frozen to a temperature in the range of −5 to −30 degrees Fahrenheit. In some embodiments, the coconut fat is frozen to a temperature in the range of −15 to −20 degrees Fahrenheit. The coconut fat utilized for the method 100 is hydrogenated coconut fat, such that it is present in a solid state and not a liquid state. The quantity of hydrogenated coconut fat first frozen may vary depending on the quantity of meat analogue to be cooked. For example, in some embodiments, the hydrogenated coconut fat ranges from 50 grams to 150 grams.

Next, the method 100 comprises flash freezing the first frozen block of coconut fat until the temperature of the first frozen block of coconut fat is reduced to a temperature in the range of −130 to −175 degrees Fahrenheit to form a second frozen block of coconut fat 104?. In embodiments, the first frozen block of coconut fat is flash frozen to a temperature of approximately −150 degrees Fahrenheit. In embodiments, the first frozen block of coconut fat is flash frozen by applying liquid nitrogen directly onto the first frozen block of coconut fat. In some embodiments, the first frozen block of coconut fat is flash frozen by immersing the first frozen block of coconut fat directly into liquid nitrogen. In other embodiments, the first frozen block of coconut is flash frozen by passing the first frozen block of coconut through a freezing tunnel, that may be mechanically frozen, which applies nitrogen gas to the first frozen block to supercool it. In alternative embodiments, the first frozen first frozen block of coconut fat is flash frozen by subjecting the first frozen block of coconut fat to an environment having a cryogenic temperature.

Note, critical to the method 100, is the foregoing two-step process of first freezing the coconut fat by regular freezing means to a temperature of −5 to −30 degrees Fahrenheit, i.e., subjecting the coconut fat to temperatures below freezing, such as by placing the coconut fat into a freezer, and second, flash freezing the already frozen coconut to a cryogenic temperature. Note, also critical to the method 100, is the order in which the coconut fat is frozen. The coconut fat must first be frozen by regular means and then flash frozen.

In some embodiments of the disclosed technology, the coconut fat or butter is dripped directly into liquid nitrogen forming sand-like particles. “Sand-like particles” are particles which have a longest diameter passing though a midpoint there of which is between 0.06 mm to 2.0 mm, inclusive. This is desirable in certain applications and can be used in certain processing applications that require very fine particles. In other embodiments, liquid is dripped into nitrogen forming discrete particles which are larger than sand-like particles. The liquid is a liquid with stabilizer which homogenizes the product having the coconut fat or butter added thereto.

Lastly, the method 100 comprises breaking the second frozen block of coconut fat into discrete frozen particles 106?. In some embodiments, the second frozen block of coconut fat is broken into the discrete frozen particles by applying a blunt force, such as by a hammer or a roller, directly to the second frozen block of coconut fat. Preferably, the second frozen block of coconut fat is broken into discrete frozen particles being pea-sized or having a diameter in the range of 7 mm to 9 mm.

In embodiments, the method 100 further comprises a step of depositing the coconut fat into an insulated container prior to first step of freezing the coconut fat into the first frozen block of coconut fat. The insulated container may be any insulated container known in the art that includes four insulated walls, an insulated base, an interior volume, and a top including an opening providing access to the interior volume. The coconut fat is deposited into interior volume of the container and the step 102 of freezing the coconut fat until the temperature of the coconut fat is reduced to a temperature in the range of −5 to −30 degrees Fahrenheit to form the first frozen block of coconut fat comprises directionally freezing the coconut fat by freezing the container with the top left open, thereby exposing the portion of the coconut fat that is adjacent to the open top, i.e., to the freezing cold environment of a freezer, for example, and freezing it directionally from top to bottom. Directionally freezing the coconut fat first at the outset of the method 100 enables removal of impurities such as air bubbles from the coconut fat while freezing.

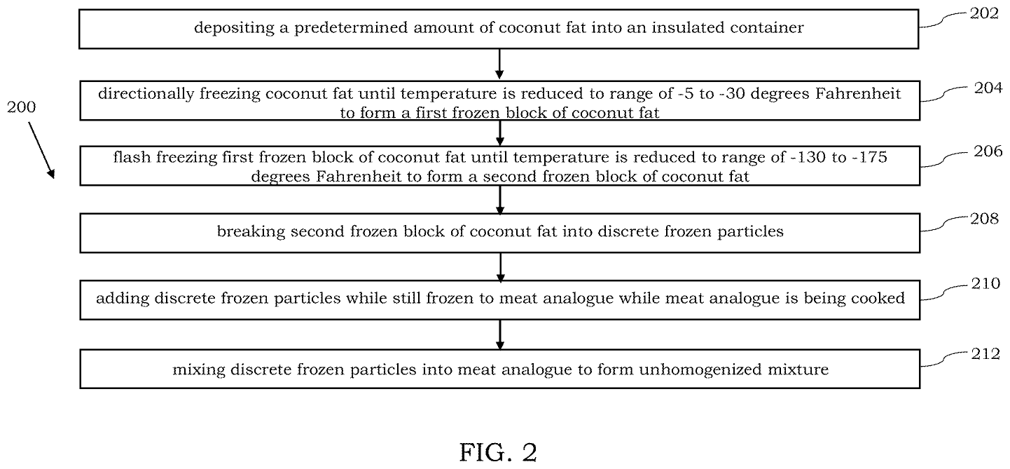

Referring now to FIG. 2, there is shown a high-level flow chart of a method of making a meat analogue with coconut fat according to one embodiment of present disclosed technology. The method 200 of making a meat analogue with coconut fat includes depositing a predetermined amount of coconut fat into an insulated container 202. The insulated container may be any insulated container known in the art that includes four insulated walls, an insulated base, an interior volume, and a top including an opening providing access to the interior volume.

Next, the method 200 comprises directionally freezing a predetermined amount of coconut fat until the temperature of the coconut fat is reduced to a temperature in the range of 50 to −30 degrees Fahrenheit 204. Freezing the coconut fat in this fashion forms a first frozen block of coconut fat. In embodiments, the coconut fat is frozen to a temperature in the range of −5 to −30 degrees Fahrenheit. In other embodiments, the coconut fat is frozen to a temperature in the range of −15 to −20 degrees Fahrenheit. The coconut fat is directionally frozen by freezing the container with the top left open, thereby exposing the portion of the coconut fat that is adjacent to the open top, i.e., to the freezing cold environment of a freezer, for example, and freezing it directionally from top to bottom. The coconut fat utilized for the method 200 is hydrogenated coconut fat, such that it is present in a solid state and not a liquid state. The quantity of hydrogenated coconut fat utilized may vary depending on the quantity of meat analogue to be cooked. For example, in some embodiments, the hydrogenated coconut fat ranges from 50 grams to 150 grams.

Next, the method 200 comprises flash freezing the first frozen block of coconut fat until the temperature of the first frozen block of coconut fat is reduced to a temperature in the range of −130 to −175 degrees Fahrenheit 206. Flash freezing the first frozen block forms a second frozen block of coconut fat that is coextensive with the first frozen block of coconut fat. In embodiments, the first frozen block of coconut fat is flash frozen to a temperature of approximately −150 degrees Fahrenheit. In embodiments, the first frozen block of coconut fat is flash frozen by applying liquid nitrogen directly onto the first frozen block of coconut fat. In some embodiments, the first frozen block of coconut fat is flash frozen by immersing the first frozen block of coconut fat directly into liquid nitrogen. In other embodiments, the first frozen block of coconut is flash frozen by passing the first frozen block of coconut through a freezing tunnel, that may be mechanically frozen, which applies nitrogen gas to the first frozen block to supercool it. In alternative embodiments, the first frozen first frozen block of coconut fat is flash frozen by subjecting the first frozen block of coconut fat to an environment having a cryogenic temperature.

Next, the method 200 comprises breaking the second frozen block of coconut fat into discrete frozen particles 208. In some embodiments, the second frozen block of coconut fat is broken into the discrete frozen particles by applying a blunt force, such as by a hammer or a roller, directly to the second frozen block of coconut fat. Preferably, the second frozen block of coconut fat is broken into discrete frozen particles being pea-sized or having a diameter in the range of 7 mm to 9 mm.

Next, the method 200 comprises adding the discrete frozen particles while still frozen to a meat analogue while the meat analogue is being cooked 210. In embodiments, the discrete frozen particles, while frozen, are added to the meat analogue while the meat analogue has finished cooking and is cooling. In some embodiments, the discrete frozen particles are introduced into the meat analogue prior to, or during, the meat analogue being cooked, and then the meat analogue is is molded into a desired shape, such as hamburger patty, sausage, nugget, or the like and frozen or chilled for later or subsequent cooking.

Lastly, the method 200 comprises mixing the discrete frozen particles into the meat analogue in an unhomogenized way 212. In some embodiments, the discrete frozen particles are mixed into the meat analogue while the meat analogue is being cooked to melt the discrete frozen particles and form an unhomogenized mixture of melted coconut fat and meat analogue. In other embodiments, the discrete frozen particles are mixed into the meat analogue after the meat analogue is being cooked and while cooling.

Any device or step to a method described in this disclosure can comprise or consist of that which it is a part of, or the parts which make up the device or step. The term “and/or” is inclusive of the items which it joins linguistically and each item by itself.

For purposes of this disclosure, the term “substantially” is defined as “at least 95%” of the term which it modifies.

Any device or aspect of the technology can “comprise” or “consist of” the item it modifies, whether explicitly written as such or otherwise.

When the term “or” is used, it creates a group which has within either term being connected by the conjunction as well as both terms being connected by the conjunction.

While the disclosed technology has been disclosed with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods and apparatuses described hereinabove are also contemplated and within the scope of the invention.

What is claimed is:

1. A method of making a meat analogue with coconut fat, comprising the steps of:
freezing coconut fat until the temperature of the coconut fat is reduced to a temperature in the range of 50 to −30 degrees Fahrenheit to form a first frozen block of coconut fat;
flash freezing the first frozen block of coconut fat until the temperature of the first frozen block of coconut fat is reduced to a temperature in the range of −130 to −175 degrees Fahrenheit to form a second frozen block of coconut fat;
breaking the second frozen block of coconut fat into discrete frozen particles;
adding the discrete frozen particles while still frozen to a meat analogue while the meat analogue is being cooked; and
mixing the discrete frozen particles into the meat analogue in an unhomogenized way while the meat analogue is being cooked to melt the discrete frozen particles and form an unhomogenized mixture of melted coconut fat and meat analogue.

2. The method of claim 1, wherein the step of flash freezing the first frozen block of coconut fat comprises applying liquid nitrogen directly onto the first frozen block of coconut fat.

3. The method of claim 2, wherein the step of breaking the second frozen block of coconut fat into discrete frozen particles comprises applying a blunt force directly to the second frozen block of coconut fat.

4. The method of claim 3, wherein the step of breaking the second frozen block of coconut fat into discrete frozen particles comprises breaking the second frozen block of coconut into discrete frozen pea-sized particles including a diameter in the range of 7 mm to 9 mm in diameter.

5. The method of claim 3, wherein the blunt force is applied with a hammer or a roller.

6. The method of claim 3, wherein the step of freezing the coconut fat until the temperature of the coconut fat is reduced to a temperature in the range of 50 to −30 degrees Fahrenheit to form a first frozen block of coconut fat comprises freezing the coconut fat until the temperature of the coconut fat is reduced to a temperature in the range of −15 to −20 degrees Fahrenheit.

7. The method of claim 6, wherein the step of flash freezing the first frozen block of coconut fat until the temperature of the first frozen block of coconut fat is reduced to a temperature in the range of −130 to −175 degrees Fahrenheit to form a second frozen block of coconut fat comprises flash freezing the first frozen block of coconut fat until the temperature of the first frozen block of coconut fat is reduced to substantially −150 degrees Fahrenheit.

8. The method of claim 7, wherein the coconut fat includes a weight in the range of 50-150 grams.

9. The method of claim 7, further comprising a step of depositing the coconut fat into an insulated container prior to freezing the coconut fat, the insulated container including four insulated walls, an insulated base, an interior volume, and a top including an opening providing access to the interior volume, wherein the coconut fat is deposited into interior volume of the container, and wherein the step of freezing the coconut fat until the temperature of the coconut fat is reduced to a temperature in the range of −5 to −30 degrees Fahrenheit to form the first frozen block of coconut fat comprises directionally freezing the coconut fat by freezing the container with the top left open and exposed to the freezing cold environment.

10. A method of making discrete frozen particles of coconut fat from coconut fat, comprising the steps of:
freezing coconut fat until the temperature of the coconut fat is reduced to a temperature in the range of 50 to −30 degrees Fahrenheit to form a first frozen block of coconut fat;
flash freezing the first frozen block of coconut fat until the temperature of the first frozen block of coconut fat is reduced to a temperature in the range of −130 to −175 degrees Fahrenheit to form a second frozen block of coconut fat;
breaking the second frozen block of coconut fat into discrete frozen particles.

11. The method of claim 10, wherein the step of flash freezing the first frozen block of coconut fat comprises applying liquid nitrogen directly onto the first frozen block of coconut fat.

12. The method of claim 11, further comprising a step of depositing the coconut fat into an insulated container prior to freezing the coconut fat, the insulated container including four insulated walls, an insulated base, an interior volume, and a top including an opening providing access to the interior volume, wherein the coconut fat is deposited into interior volume of the container, and wherein the step of freezing the coconut fat until the temperature of the coconut fat is reduced to a temperature in the range of 50 to −30 degrees Fahrenheit to form the first frozen block of coconut fat comprises directionally freezing the coconut fat by freezing the container with the top left open and exposed to the freezing cold environment.

13. The method of claim 12, wherein the step of breaking the second frozen block of coconut fat into discrete frozen particles comprises applying a blunt force directly to the second frozen block of coconut fat, wherein said discrete frozen particles are sand-like particles.

14. The method of claim 12, wherein the step of breaking the second frozen block of coconut fat into discrete frozen particles comprises breaking the second frozen block of coconut into discrete frozen pea-sized particles including a diameter in the range of 7 mm to 9 mm in diameter.

15. The method of claim 13, wherein the blunt force is applied with a hammer or a roller.

16. The method of claim 12, wherein the step of freezing the coconut fat until the temperature of the coconut fat is reduced to a temperature in the range of −50 to −30 degrees Fahrenheit to form a first frozen block of coconut fat comprises freezing the coconut fat until the temperature of the coconut fat is reduced to a temperature in the range of −15 to −20 degrees Fahrenheit.

17. The method of claim 16, wherein the step of flash freezing the first frozen block of coconut fat until the temperature of the first frozen block of coconut fat is reduced to a temperature in the range of −130 to −175 degrees Fahrenheit to form a second frozen block of coconut fat comprises flash freezing the first frozen block of coconut fat until the temperature of the first frozen block of coconut fat is reduced to a substantially −150 degrees Fahrenheit.

18. The method of claim 17, wherein the coconut fat includes a weight in the range of 50-150 grams.

19. The method of claim 18, further comprising the step of adding the discrete frozen particles while still frozen to a meat analogue while the meat analogue is being cooked.

20. The method of claim 19, further comprising the step of mixing the discrete frozen particles into the meat analogue in an unhomogenized way while the meat analogue is being cooked to melt the discrete frozen particles and form an unhomogenized mixture of melted coconut fat and meat analogue.
